(19) United States
(12) Patent Application Publication
(10) Pub. No.: US 2014/0181939 A1
(43) Pub. Date: Jun. 26, 2014

(54) CLOUD COMPUTING EXCHANGE FOR IDENTITY PROOFING AND VALIDATION

(71) Applicant: United States Postal Service, Washington, DC (US)

(72) Inventor: Clayton Craig Bonnell, Washington, DC (US)

(73) Assignee: United States Postal Service, Washington, DC (US)

(21) Appl. No.: 14/107,437

(22) Filed: Dec. 16, 2013

Related U.S. Application Data
(60) Provisional application No. 61/737,545, filed on Dec. 14, 2012.

(51) Int. Cl. H04L 29/06

(52) U.S. Cl. CPC H04L 63/08
USPC 726/7

(57) ABSTRACT

An architecture and method to provide a cloud based credential exchange wherein organizations and users can use the services of a centralized and streamlined credential clearing house. A user can provide credentials or verification from a third party credential provider to the credential exchange. The credential exchange can use the third party credentials to provide access to multiple networks affiliated with the credential exchange.

### INCORPORATION BY REFERENCE TO ANY PRIORITY APPLICATIONS

Any and all priority claims identified in the Application Data Sheet, or any correction thereto, are hereby incorporated by reference under 37 CFR 1.57. For example, this application claims the benefit of Provisional Application No. 61/737,545 in the U.S. Patent Office on Dec. 14, 2012, the disclosure of which is incorporated herein by reference in its entirety.

### BACKGROUND

1. Field

This disclosure relates to a computer network, system and method providing a cloud based exchange for proving and validating identity for accessing one or more applications or accessing one or more networks.

### SUMMARY

One embodiment includes a method of allowing network access, wherein the method includes requesting a first set of credentials, wherein the first set of credentials allows a user access to a first application; receiving the first set of credentials; associating the first set of credentials with a second set of credentials, wherein the second set of credentials allows the user access to a second application, and wherein the second set of credentials are associated with a network identity; validating the network identity of the user according to the first and second set of credentials; and allowing access to the second application according to the validated network identity based on the first set of credentials.

In some embodiments, the first set of credentials has a first security requirement and the second set of credentials has a second security requirement.

In some embodiments, validating the network identity of the user comprises evaluating the first security requirement and the second security requirement and determining whether the first security requirement of the first set of credentials is sufficient to meet the second security requirement.

### BRIEF DESCRIPTION OF THE DRAWINGS

These drawings and the associated description herein are provided to illustrate specific embodiments of the invention and are not intended to be limiting.

FIG. 1 is a system diagram of a cloud based credential exchange architecture according to an embodiment.

FIG. 2 is a flow chart illustrating a process wherein a user requests access to an application according to an embodiment.

FIG. 3 is a flow chart illustrating a process wherein a user requesting access to an application is authenticated according to an embodiment.

FIG. 4 is a flow chart illustrating a process wherein an authentication assertion is created and sent according to an embodiment.

FIG. 5 is a flow chart illustrating a process wherein a user may link multiple credentials together according to an embodiment.

FIG. 6 is a flow chart illustrating a process wherein the lifecycle of a third party provider is managed according to an embodiment.

FIG. 7 is a flow chart illustrating a process wherein the applications are notified of a change in the lifecycle of a third party provider according to an embodiment.

FIG. 8 is a flow chart illustrating a process wherein an application may request additional user attributes according to an embodiment.

FIG. 9 is a flow chart illustrating a process wherein a user is authenticated according to an embodiment.

FIG. 10 is a flow chart illustrating a process wherein a user may link multiple credentials together for future use according to an embodiment.

FIG. 11 is a flow chart illustrating a process wherein an application may request additional user attributes according to an embodiment.

FIG. 12 is a block diagram of a cloud based credential exchange architecture according to an embodiment.

### DETAILED DESCRIPTION

The disclosure presents embodiments of a system and method of proving and validating identity for an application or network, such as for use on the website of one or more organizations. The identity of a user may be stored and/or accessed for proving or validating using a cloud based credential exchange architecture. In some embodiments, the user's identity or credentials for a third-party application or website may be used to prove or validate the user's identity for access to one or more applications or websites. Detail regarding some exemplary embodiments follows.

Those of skill will recognize that the various illustrative logical blocks, modules, circuits, and algorithm steps described as follows, and in connection with the embodiments disclosed herein may be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Some embodiments disclosed herein describe a providing a credential exchange for interrelated systems, such as a corporation having multiple networks or access points, a health care system having multiple networks, government agencies, each of which has its own network, where each network or system of the interrelated systems requires verification of credentials prior to providing access. A credential exchange allows interrelated organizations or networks an intermediary so the interrelated organizations or systems need only interact with and link to a single entity to validate the entities of their users.

As a non-limiting example, if a user has a Google, PayPal, and/or Verizon credential (who are exemplary third party providers), a user may choose to rely on one or more of these credentials when logging in to one or more of the networks or systems associated with the credential exchange. If the user has a Google, PayPal, and Verizon account, the credential exchange may link all these accounts as belonging to the same user. A user having a PayPal account may desire to rely on an identity and credentials previously established while registering for the PayPal account for use on a government agency's network. By using the credential exchange, a user accesses the credential exchange via the government agency's network, and the user inputs his PayPal credentials. The credential exchange receives confirmation from PayPal that the user's credentials are valid. The government agency whose network the user is seeking to access may have certain security or identification requirements, or require that a user's credential have a specific Level of Assurance (LOA). If the PayPal credentials meet the required LOA, the credential exchange sends a second set of credentials, based on the PayPal credentials which authenticate or verify the user to the government agency network. If the PayPal credentials do not meet the required LOA, the credential exchange may request additional information regarding the user. This information may be obtained from the credential exchange, and may linked to the user. The credential exchange may request the additional information from other third party providers, such as Google or Verizon, in order to obtain the necessary LOA. The credential exchange may request additional verification from the user. Once the necessary LOA is received, the credential exchange can generate a second set of credentials for accessing the government agency's network.

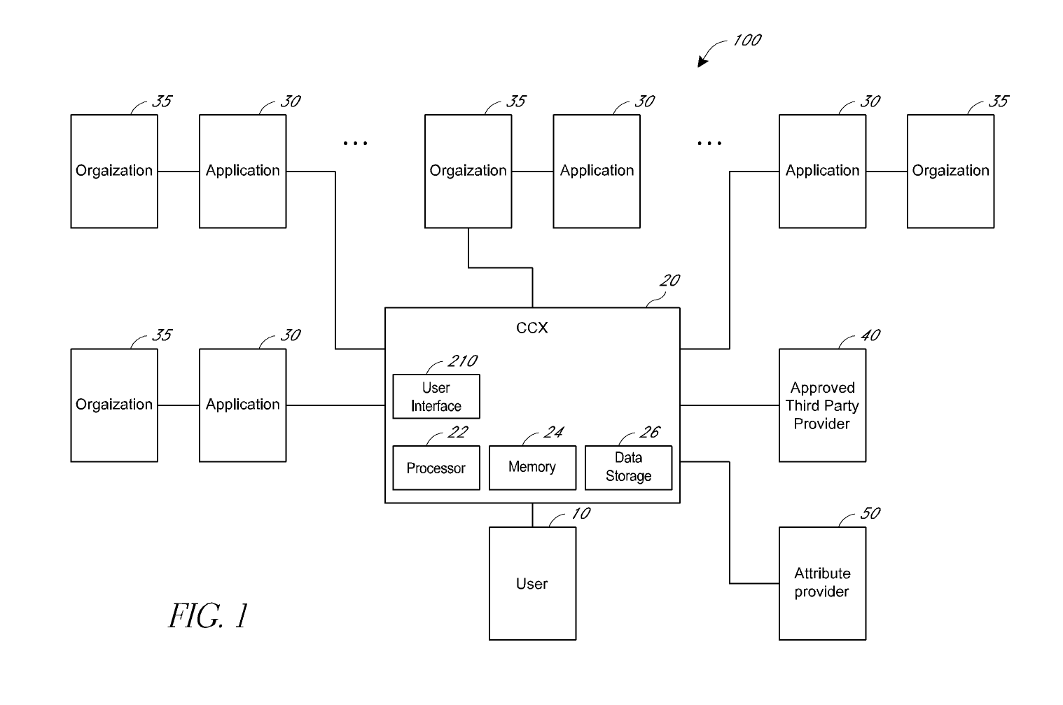

FIG. 1 illustrates an embodiment of a system 100 comprising a cloud based credential exchange architecture. Cloud Credential Exchange (CCX) 20 includes a processor 22, a memory 24 and a data storage 26. The CCX 20 can be embodied on a server connected to a network, or on one or more computers in communication with each other.

The memory 24 can be configured to store operating instructions to direct operation of the processor 22. Data storage 26 is a data repository configured to store information used by the processor 22 be configured to include data structures, meta data and configurations related to or defining the systems the CCX 20 interfaces with. For example, the data storage 26 may be configured to maintain configuration information about the third party providers 40, including the name of the third party provider 40, its credential type, level of assurance (LOA), attributes the third party provider 40 collects about a user 10, and the particular approved communication scheme of the third party provider 40. Further details of the configuration of the third party provider 40 may be included, for example, the physical type of credentials that the third party provider 40 issues to the user 10. Examples of credentials may include passwords, one time passwords, hard tokens and software certificates.

The data storage 26 may further include configuration information on an application 30 including, the name of the application 30, the name of the organization 35 which hosts the application 30, and the LOA required by the application 30 for authentication. If the application 30 has multiple functions that require different LOAs then each function of the application 30 might be stored in the data storage 26 with the LOA requirement. Data storage 26 may include additional configuration information on an application 30, for example the protocol requirements of the application 30 and assertion requirements of the application 30. Assertion requirements may include information on the specifics of how the application 30 may expect to receive an assertion notification. The information may include both the type of the assertion and what additional information may be included therewith, for example, a user 10 identifier or user 10 attributes. The CCX 20 will use the configuration information stored in the data storage 26 to construct an appropriate assertion notification for an application 30.

Additionally, the data storage 26 may further include configuration information on a user 10, for example, the user 10 identifier (user ID), credential user ID, which may contain the unique identifier for a given third party provider 40 credentials, accounts credentials, which may contain the metadata representing the type of account or credential that the user 10 holds for a given third party provider 40 and the user 10 attributes, which may contain metadata pointing to the location and the set of attributes that the CCX 20 can obtain for a user 10.

The data storage 26 may further include configuration information on an organization 35, for example, the name of the organization and notification settings such as the type and frequency of communication that the organization 35 requires. Examples may include an organization 35 requiring a push type of communication for receiving a notification, and another organization 35 requiring a pull type of communication for receiving a notification.

The data storage 26 may further include additional information on trusted certificate authorities in order to validate certificates from certificate-based authentication mechanisms, for example from PIV cards. The data storage 26 may further include additional configuration information on attribute providers 50, for example, the name of the attribute provider 50, the user 10 unique identifier, which may contain the unique identifier that an attribute provider 50 requires in order to identify a user 10 and information on the set of attributes provided by an attribute provider 50.

The CCX 20 is configured to implement cloud-based services that can provide various interrelated organizations 35, such as, for example Federal agencies, access to the websites or online tools provided by the organizations 35. The organizations 35 can be accessed via a corresponding application 30, which is configured to provide a user interface to the systems, products, services, and other features offered by the organizations 35. Although applications 30 are described herein as being web or internet applications, a person of skill in the art understands that the applications of this disclosure are not limited to those applications accessible only over the world wide web, but may also include access portals on any wired or wireless network.

The third party credential provider 40 and attribute provider 50 may be a network or internet service configured to provide identity verification and credential verification for users who desire access to computers, systems, and services over wired and wireless networks. The third party provider 40 and the attribute provider 50 may be implemented as part of the CCX 20 server or implemented separately from the CCX 20. The attribute provider 50 may be implemented as part of the CCX 20 or as a separate provider to interface with the data storage 26, and the processor 22, in order to provide additional information or attributes regarding a user 10 profile to the CCX 20 or the third party provider 40.

The CCX 20 provides various organizations 35 an ability to accept a variety of approved third-party credentials for access to the organizations' 35 online services. The third party credential providers 40 described herein may be, for example, third party providers which are approved under the Federal Identity, Credential, and Access Management (FICAM) initiative. Moreover, the CCX 20 enables organizations 35 to offer a variety of online services to its users without requiring a single user to have or provide credentials and/or access information for each organization separately. The CCX 20 allows a user to access the applications 30 of multiple various organizations 35 without needing to receive, sign up for, or provide different credentials for each organization.

In some embodiments, a user 10 may use system 100 to request access to the application 30 of an organization 35 via a user interface (UI). The user 10 can use a third party credential from an approved third party credential provider 40 to login to the application 30. The third party credential can be a third party provider who has registered with the CCX 20, or who has been authorized by the CCX 20. Third party providers may include, for example, PayPal, Google, credit card companies, and others with whom the user 10 may have registered. Upon login to the application 30, the CCX 20 may display the list of third party providers for the user 10 to select from. The application 30 can present the user 10 with credential service providers 40 to access the application in variety of ways. For example, the application 30 can present the credential service providers 40 on its user interface (not shown). When a user 10 accesses the user interface of the application 30, the application 30 may request and receive from the CCX 20 a managed list of third party credential service providers 40 available at the appropriate level of assurance (LOA) required by the application 30. In some embodiments, the list is dynamically implemented, that is, the list may be different for different applications 30. The CCX 20 can manage and update the list of third party credential service providers which are displayed on a user interface of the application 30.

In some embodiments, the application 30 may redirect a user 10 requesting login to the user interface 210 of the CCX 20. The user 10 may then be presented with a list of available third party credential service providers 40 at the appropriate LOA. The user may select a third party provider 40 with whom the user has previously registered, such as PayPal, a bank, Google, or others. The user 10 can input his or her credentials for accessing the third party provider. If the third party provider 40 receives valid user credentials, the CCX 20 receives an authentication message from the third party provider 40, indicating that the user 10 has input valid credentials and is verified. The CCX 20 may generate a second set of credentials, and provide these credentials to the application 30 of the organization 35, whereby the application 30 grants the user 10 access. The list of third party credential service providers 40 may be managed and updated by the CCX 20.

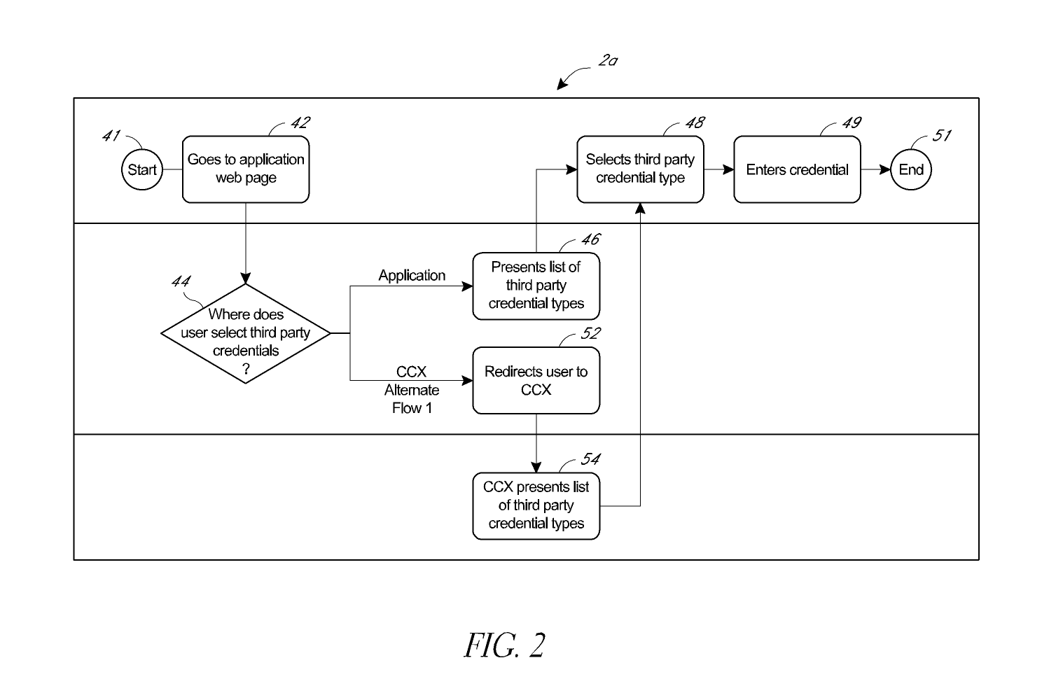

Exemplary processes and algorithms for authenticating a user 10 requesting access to the application 30 according to an embodiment will further be described below in relation to FIGS. 2, 3 and 4.

In FIG. 2, the process 2a begins in step 42, wherein the user 10 may request login by navigating to the application 30 user interface, such as a network access portal, web page, or the like. In decision state 44, the user 10 selects the type of credentials he would like to use to access the application 30. If the Applicant wishes to select a third party credential type the proceeds to step 46, wherein the application 30 presents a list of the third party credential providers 40 to the user 10 in step 46. The process 2a moves to step 48, wherein the user 10 selects a third party credential provider 40 and enters the credentials of the user 10 in step 49. The process then ends in step 51.

If the user 10 desires to use the CCX 20, a list of the third party providers 40 is received from the CCX 20, the process 2a moves to block 52, wherein the user is redirected to the CCX 20's user interface 210, and the user is presented with a list of pre-authorized credential providers 40. The process moves to step 54, the CCX 20 presents the user with a list of third party credential providers 40. The process 2a next moves to step 48, where the user 10 selects a third party credential provider 40, and enters the credentials of the user 10 in step 49. The process ends in step 51.

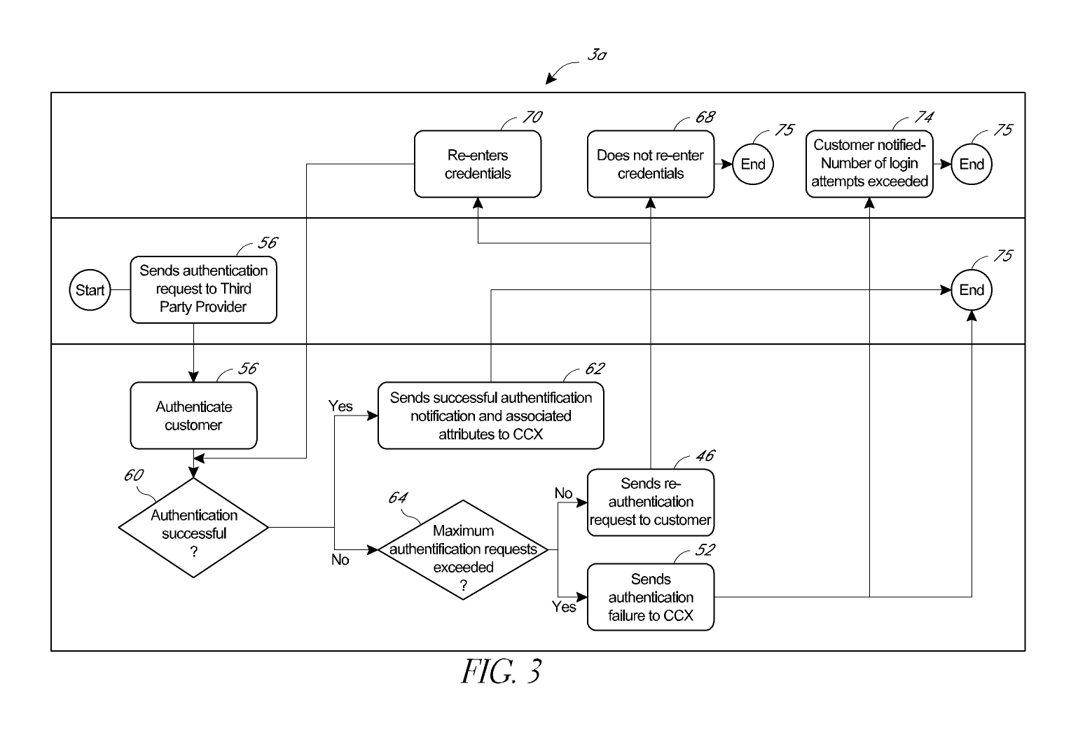

FIG. 3 depicts a process 3a. In some embodiments, process 3a occurs following process 2a, after a user enters the third party provider 40 credentials. The process 3a begins in step 56 wherein the CCX 20 sends an authentication request to the third party provider 40. The process moves to step 58, wherein the third party provider 40 authenticates the credentials of the user. The process moves to decision state 60, wherein the authentication is determined to be successful or unsuccessful. If the authentication is successful, the process moves to step 62 wherein the a notification of successful authentication is sent to the CCX 20.

If the authentication is unsuccessful, the process continues to decision state 64, wherein the third party provider 40 determines whether the user 10 has exceeded its maximum authentication requests. If the user has not exceeded a maximum number of attempts, the process moves to step 66, wherein the third party provider 40 sends a re-authentication request to the user 10. The user 10 may decide to not reenter its credentials in step 68 thereby ending the process 3a in step 75. Alternatively, the user may choose to reenter its credentials in step 70, in which case, the newly entered credentials may be transmitted to the third party provider 40. The process returns to decision state 60, wherein the process 3a repeats.

If it is determined in step 64 that the party has exceeded a maximum number of attempts, such as 3, 4, 5, or any other desired number, the process moves to step 72, wherein the third party provider 40 sends an authentication failure message to the CCX 20. The CCX 20 may then notify the application 30 of the failed attempt to authenticate. The process 3a moves to step 74, wherein the application 30 provides an error message to the user 10 and denies access to the application 30. The process ends in step 75. In some embodiments, the process 3a may be terminated at step 72 without generating an error message for the user 10.

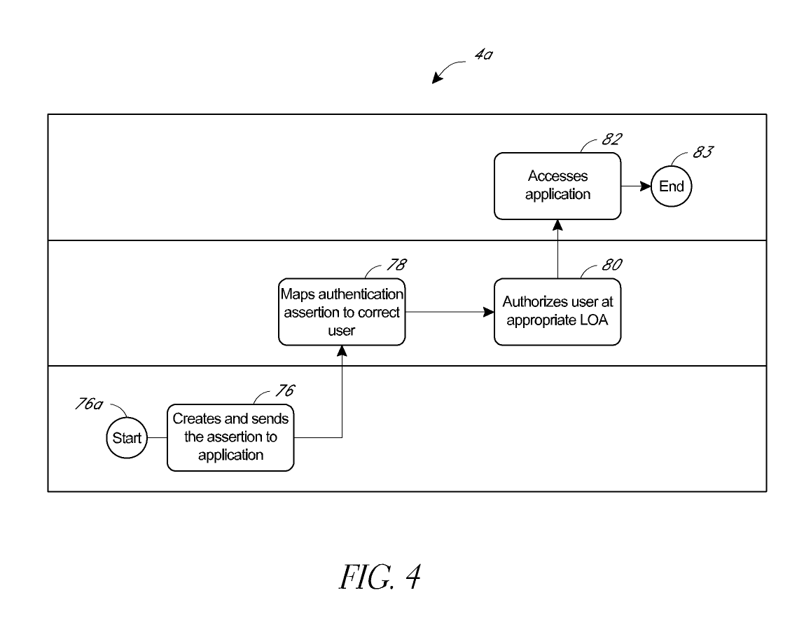

FIG. 4 depicts a process 4a, which may occur following process 3a, wherein the third party provider 40 has successfully authenticated a user 10 and has sent the CCX 20 a user authentication notification. Additionally, the third party provider 40 may furnish the CCX 20 with additional attributes associated with the user 10. The process begins in step 76 once a user 10 has been successfully authenticated. The process 5a moves to step 78, wherein the application 30 maps the authentication assertion to the correct user 10. The process moves to step 80, wherein the application 30 authorizes the user 10 at the appropriate level of LOA required for the user 10. The process 4a ends in step 82 when the application 30 grants access to the application 30.

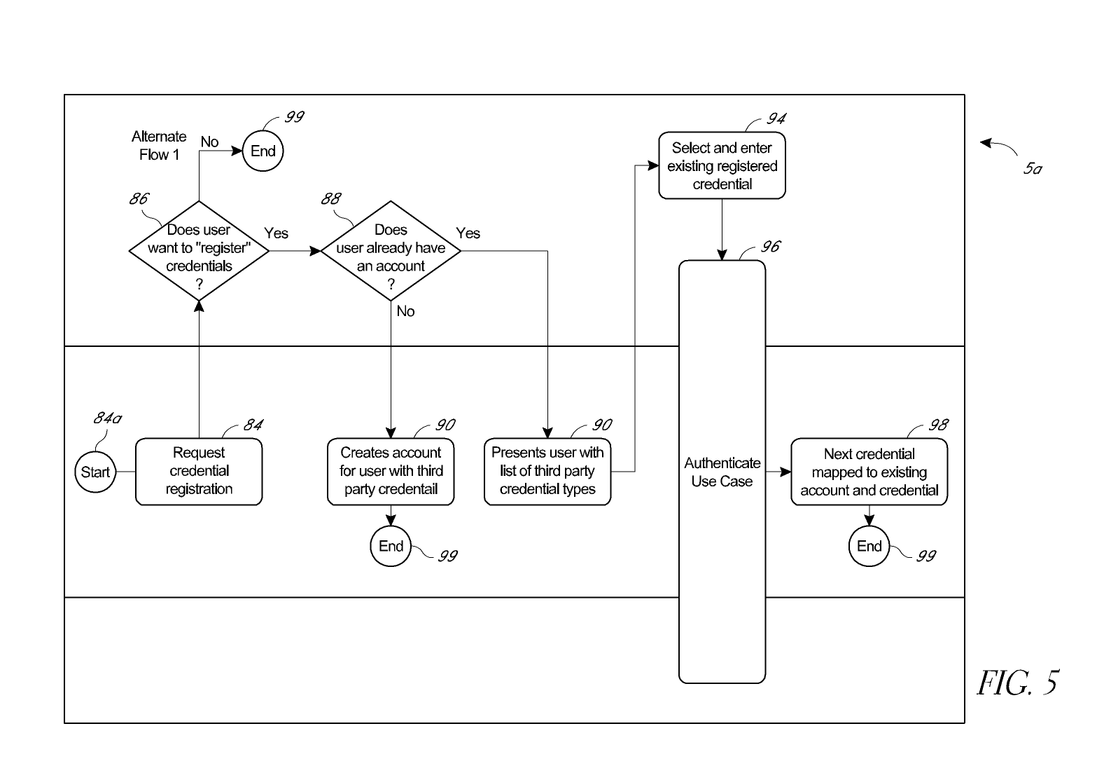

FIG. 5 depicts a process 5a, wherein the CCX 20 may be used to provide an optional service to the application 30 and the user 10. The CCX 20 may be implemented to link multiple credentials from different credential service providers 40 to the profile of a user 10. The process begins in step 84, wherein the CCX 20 presents the user 10 with an option to register additional credentials for future use. The process 5a moves to decision state 86, wherein the user may decide not to register any credentials, thereby terminating the process 5a. If the user 10 decides to register additional credentials for future use, the process 5a continues to the decision state 88, wherein the user 10 is queried on whether or not the user 10 has an account with the CCX 20. If the user selects “No,” the CCX 20 may create an account for the user 10 with the third party credentials and the process 5a ends in step 90. If the user selects “Yes” the process moves to step 92, wherein the CCX 20 presents the user 10 with a list of third party provider 40 credential types already associated with the user 10 in the CCX 20. The CCX 20 provides the existing third party provider 40 credential types. The process 5a continues to step 94, wherein the user 10 selects a third party provider 40 from the list, and enters an existing registered credential. The process moves to step 96, wherein the process 5a invokes the process 3a to authenticate the user 10 using the recently entered credentials. The process 5a moves to step 98, wherein the CCX 20 maps the new credentials to the credential that has already been registered, thereby ending the process 5a in step 99.

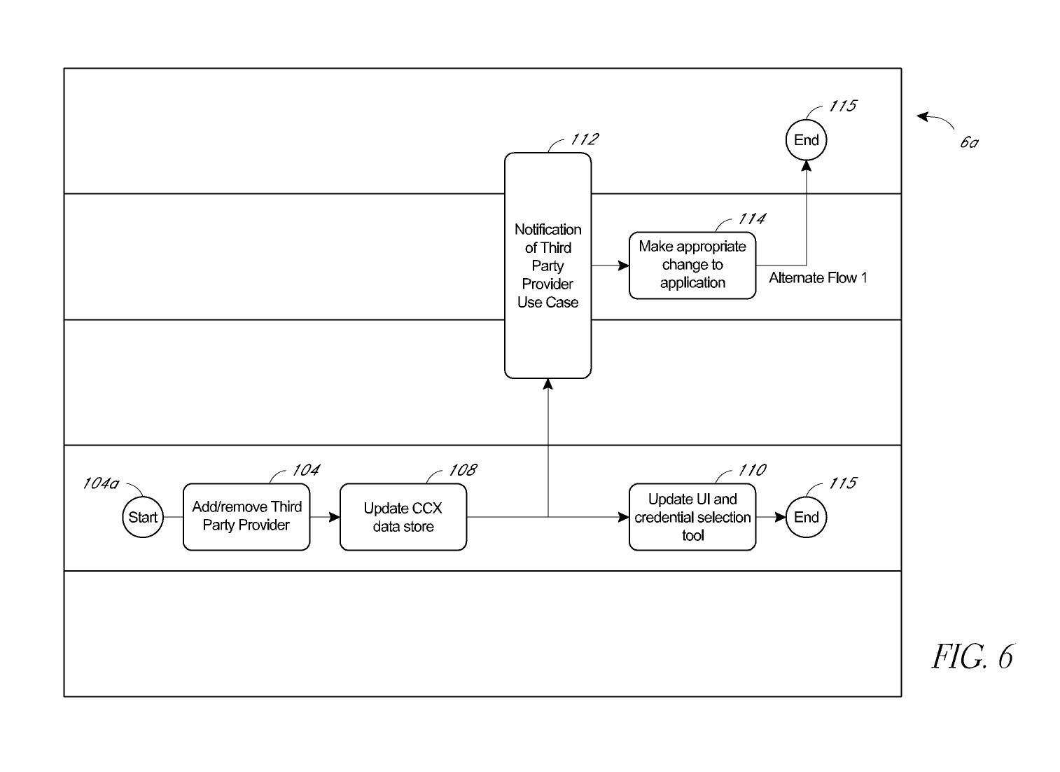

FIG. 6 depicts a process 6a, wherein third party providers 40 are managed. The process begins in step 104, wherein a CCX administrator 102 or the CCX 20 via the processor 22 might add (or on-board) a new third party provider 40, or might remove (or off-board) an existing third party provider 40. The process 6a moves to step 108, wherein the CCX administrator 102 updates the list of the third party providers 40 in the data storage 26 of the CCX 20. In some embodiments, the processor 22 of the CCX 20 may automatically update the list of third party providers 40 in the data storage 26 of the CCX 20. The process 6a moves to step 110, wherein the CCX administrator 102 or the processor 22 of the CCX 20 updates the UI and the credential selection tool of the CCX 20. The process next moves to step 112, wherein the CCX administrator 102 and/or the CCX 20 via the processor 22 invokes a process wherein the CCX 20 notifies the application 30 of the change in life cycle of the third party provider 40, such as will be described below. The process moves to step 114 wherein an application administrator 100 or the CCX 20 makes the appropriate changes to the application 30 thereby ending the process 6a.

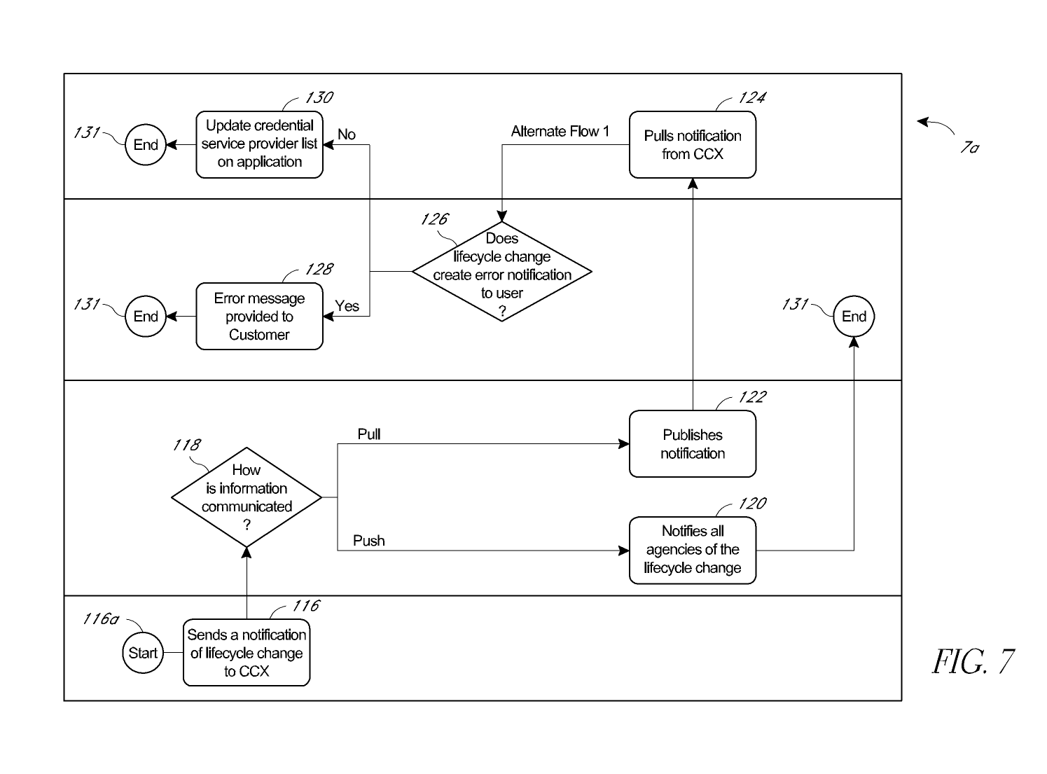

FIG. 7 depicts a process 7a. Process 7a describes a process where the CCX 20 notifies the application 30 of the change in life cycle of the third party provider 40.

Process 7a begins in step 116, wherein a third party provider 40 sends a notification of its lifecycle change to the CCX 20. In the decision state 118, the CCX 20 determines how the information is to be communicated to the organizations 35. In some embodiments, the information might be communicated to some organizations 35 using a pull method or the information might be communicated to some organizations 35 using a push method.

If the notification is to be pushed to an organization 35, the process moves to step 120, wherein the CCX 20 may notify the organization using a push method, and the process ends in step 131. If the notification is to be pulled by the organization 35, the process moves to step 122, wherein the CCX 20 publishes the notification. The process next moves to step 124, wherein the application administrator 100 or the application 30 pulls the notification from the CCX 20. In decision state 126, the application 30 determines whether the change in the lifecycle of a third party provider 40 has occurred, and, if so, the application 30 creates an error notification to the user 10. If yes, the process 7a moves to step 128, wherein the application 30 provides an error message to the user 10. If the change in the lifecycle of a third party providers 40 does not create an error for the user 10, then the process moves to step 130, wherein the application administrator 100 or the application 30 might update the list of the third party provider 40 on the application 30, following which the process ends in step 131.

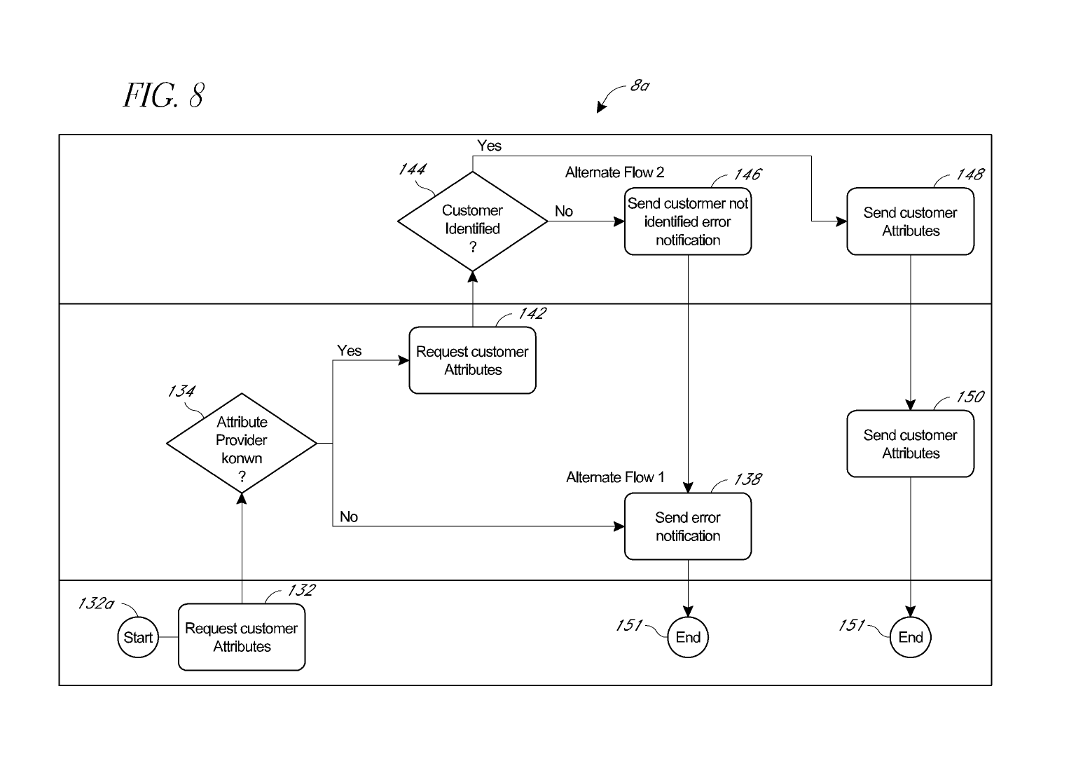

FIG. 8 depicts a process 8a, wherein an application 30 may request additional attributes for a user 10. The CCX 20 may be optionally configured to provide additional information or attributes associated with a user 10. Additional attributes, for example, can be used to further authenticate the user 10 or for other purposes. The process 8a begins in step 132, wherein the application 30 sends a request for additional attributes. The CCX 20 may use an attribute provider 50, as part of its own configuration or as an independent server, to provide additional attributes. In decision state 134, the CCX 20 determines whether it knows the attribute provider 50 for the requested attributes in step 132. If the CCX 20 does not know the attribute provider 50, the process 8a moves to step 138, wherein the CCX 20 sends an error notification to the application 30. The process ends in step 151. If it is determined in decision state 134 that the attribute provider is defined, for example, the process moves to step 142, wherein the CCX requests the attributes of the user 10 from the attribute provider 50.

In the decision state 144, the attribute provider 50, determines whether the user 10 is identified in its database. If the user 10 is not defined in the database of the attribute provider 50, then in step 146, the attribute provider 50, sends a “user not identified” error notification to the CCX 20. The process moves to step 138, wherein the CCX 20 sends an error notification to the application 30. If however, it is determined in decision state 144 that the user 10 is identified in the database of the attribute provider 50, the process moves to step 148 wherein the attribute provider 50 sends the user 10 attributes to the CCX 20, which, in turn, in step 150, sends the user 10 attributes to the application 30, and the process 8a ends.

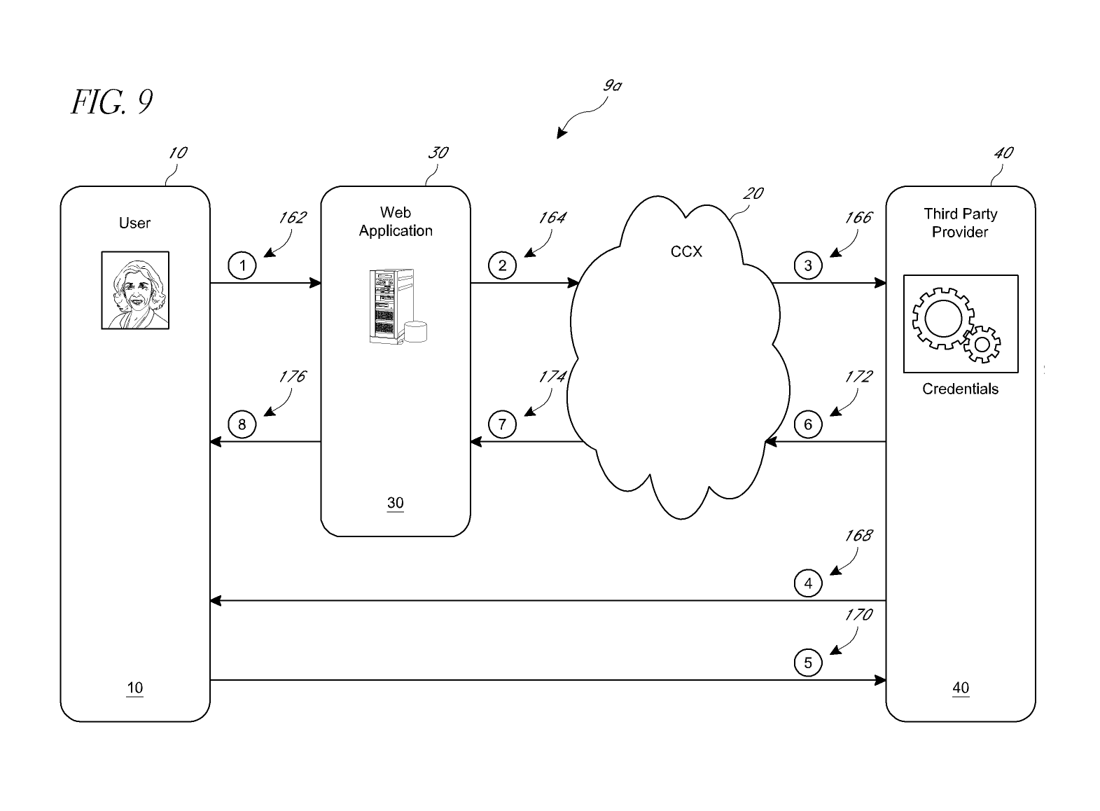

FIG. 9 depicts a process 9a, which illustrates an embodiment of a method of authenticating a user 10. The process begins in step 162, wherein a user attempts to access the application by navigating to the landing page of the application 30. The process moves to step 164, wherein the authentication request of the user 10 is routed to the CCX 20. The user 10 may select the third party provider 40 credentials directly from the landing page of the application 30 or the user might be redirected to the UI 210 of the CCX 20. In step 166, the CCX 20 routes the credential request to a third party provider 40, for example a FICAM third party provider 40. In step 168, the third party provider 40, requests authentication from the user 10. In step 170, the user 10 enters its authentication information, which is transmitted to the third party provider 40. In step 172, the third party provider authenticates the user 10 and may send attributes to the CCX 20. In step 174, the CCX 20 sends an authentication assertion to the application 30. In step 176, the application 30 authorizes and grants the user 10 access to the application 30, thereby ending the process 9a.

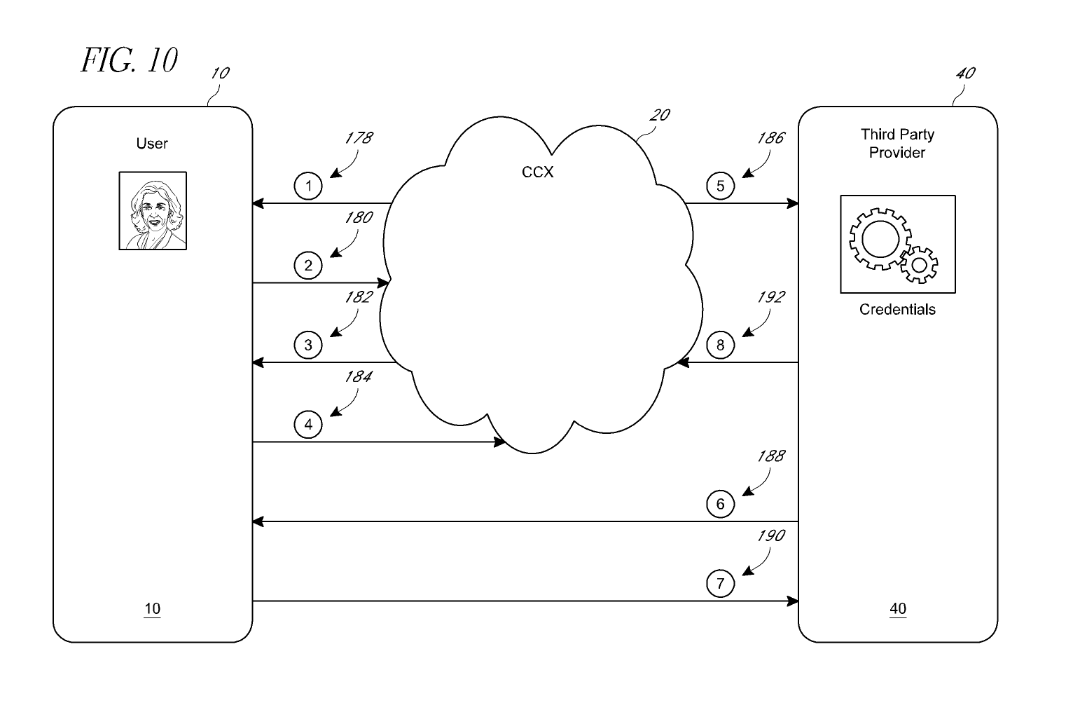

FIG. 10 depicts a process 10a illustrating an embodiment of an optional functionality of account linking. A user 10 may opt to link some or all of its third party credentials to the CCX 20 profile of the user 10. The process 10a depicts a user 10 registering its credentials with the CCX 20 for use at a later time or to correlate multiple third party credentials to one CCX 20 profile of the user 10.

The process 10a begins in step 178, wherein the CCX 20 asks the user 10 whether the user 10 wants to register its third party provider 40 credential. The process moves to step 180, wherein the user 10 registers the third party provider 40 credential and the CCX 20 stores the registration information in the data storage 26. The process 10a next moves to step 182, the CCX 20 asks the user 10 if it wishes to register and link additional credentials from other third party providers 40. In step 184, the user 10 may select additional third party credential to link. In step 186, the CCX 20 routes the credential request to the third party provider 40, for example, a FICAM third party provider 40. In step 188, the third party provider 40 requests authentication from the user 10. In step 190, the user 10 enters its authentication information which is sent to the third party provider 40. In step 192, the third party provider 40 authenticates the user 10 and may send attributes to the CCX 20. The CCX 20 might then link the credentials for later use, thereby ending the process 10a.

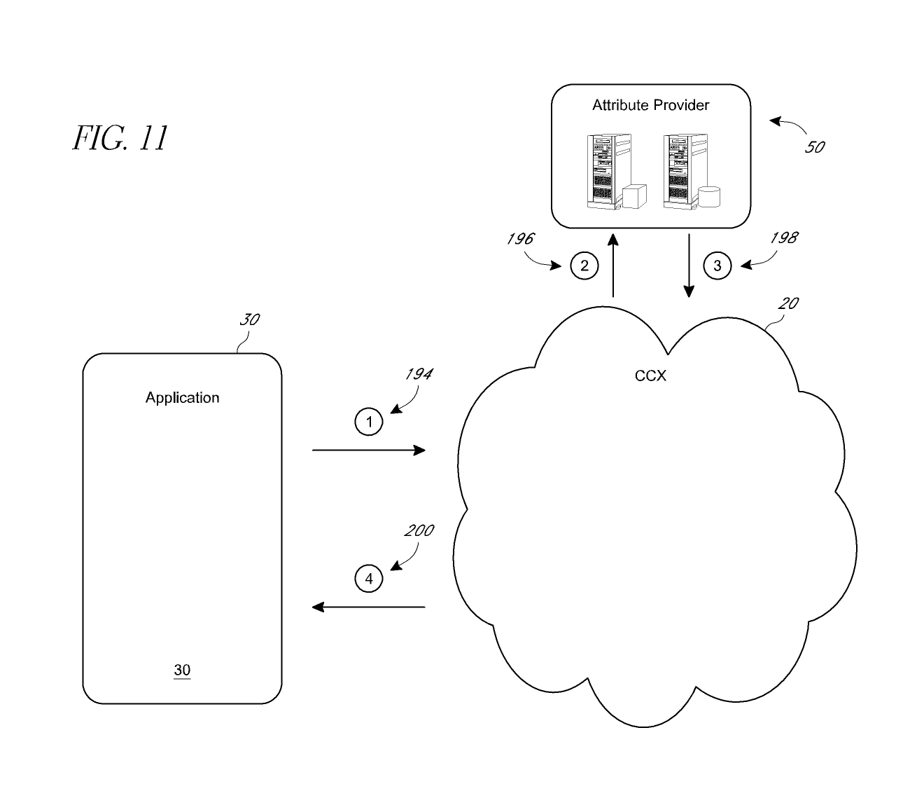

FIG. 11 depicts a process 11a, wherein an additional functionality of attribute identification is implemented. The application 30 may utilize the process 11a to request additional attributes associated with a user 10. The process begins in step 194, wherein the application 30 requests additional attributes for a user 10 from the CCX 20. In step 196, the CCX 20 identifies the appropriate attribute provider 50 and requests the attributes from the attribute provider 50. In step 198, the attribute provider 50 prepares the user 10 attributes and distributes them to the CCX 20. In step 200, the CCX 20 sends the user 10 attributes to the application 30, thereby ending the process 11a.

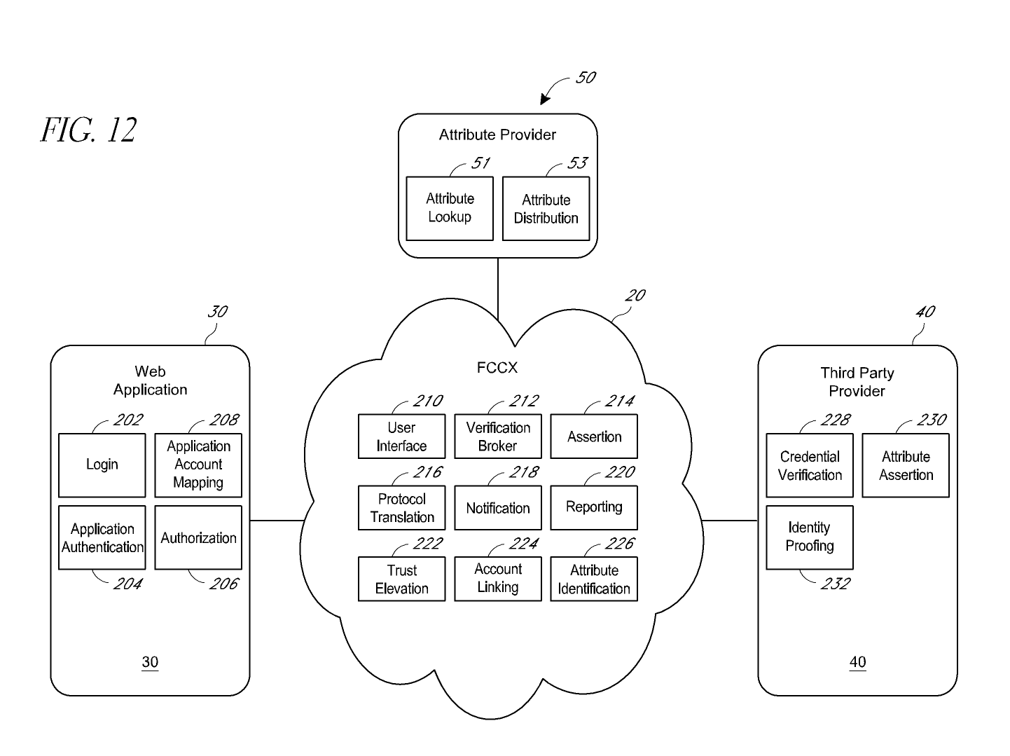

FIG. 12 depicts an embodiment of an architecture of a cloud based credential exchange according to an embodiment. For example, the application 30 may include the login 202, that provides the UI of the application 30 allowing a user 10 to authenticate using for example a third party provider 40 credential. The application 30 may further include an application authentication 204, which provides authentication to the user 10 at the application 30 webpage. The application 30 may further include the authorization module 206, which performs authorization decisions for a user 10 access to the application 30. The application 30 may further include an application account mapping 208, which performs a binding of a third party provider 40 credential with the application 30 profile of the user 10.

The CCX 20 may include a user interface 210, which may provide a graphical web-based interface through which the user 10 may select a third party provider 40 credential. The CCX 20 may further include the credential verification broker 212, which may provide an interface between the application 30 and the credential providers. The credential providers need not, but may include FICAM third party providers 40 for third party credentials and the federal bridge for federally issued PIV cards.

The CCX 20 may further include an assertion module 214, which may be configured to create a packet of information related to the user 10 in response to a request for user authentication from the application 30. In some embodiments, the packet of information can be a second set of credentials provided by the CCX 20 to the application 30 to verify the identity of the user 10. The CCX 20 may further include protocol translation 216, which may enable the communications between the CCX 20, the third party providers 40 and the application 30. The protocol translation 216 may additionally be used to establish a mechanism for registering and communicating with the new third party providers 40. The CCX 20 may further include a notification module 218, which may be used for communication between the CCX 20, organizations 35 and their respective applications 30. The CCX 20 may further include a reporting module 220, which may be used to generate reports in the CCX 20, including but not limited to, reports for auditing and business operations. The CCX 20 may further include, a trust elevation module 222 which may be implemented to use predetermined information to increase the trust associated with the interaction of a user 10 and an application 30.

The CCX 20 may further include an account linking module 224, which may be used to link the third party provider 40 credentials of a user 10 to a single profile within the CCX 20 associated with the user 10. The account linking module 224 may be implemented to work in conjunction with the assertion module 214 to populate the user identifier in a manner that identifies the identity of the user 10 rather than a specific credential associated with a third party provider 40. The CCX 20 may further include an attribute identification module 226, which may be used to identify attribute providers that hold attributes associated with a user 10. For example, an application 30 may invoke attribute identification module 226 to obtain attributes associated with a user 10 beyond what may have been provided in the assertion message sent from the CCX 20 when the user 10 was being authenticated. The attribute identification module 226 may identify appropriate attribute providers 50 and retrieve the requested attribute.

The third party providers 40 may include credential verification 228, which may confirm the authentication request from a user 10 outputting a reply of success or failure of the authentication. The third party provider 40 may further include attribute assertion 230, which can find and provide attributes associated with a user 10 to confirm or validate the credentials or identity of a user 10. The attribute assertion service 230 may be used to send the success or failure of authentication to the CCX 20 along with any additional attributes that may be requested or found to be associated with a user 10. The third party provider 40 may further include an identity proofing 232, which may be used to vet and verify information such as identity history, credentials, documents or other information used to establish the identity of a user 10 before issuing a credential.

Attribute provider 50 may include attribute lookup 51, which may be used to identify and prepare attributes associated with a user 10. Attribute provider 50 may further include attribute distribution 53, which may be used to send the attributes identified and prepared by the attribute look up 51 to the CCX 20.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor reads information from, and write information to, the storage medium. In the alternative, the storage medium may be integral to the processor. The processor and the storage medium may reside in an ASIC.

While the above detailed description has shown, described, and pointed out novel features of the development as applied to various embodiments, it will be understood that various omissions, substitutions, and changes in the form and details of the device or process illustrated may be made by those skilled in the art without departing from the spirit of the development. As will be recognized, the present development may be embodied within a form that does not provide all of the features and benefits set forth herein, as some features may be used or practiced separately from others. All changes which come within the meaning and range of equivalency of the claims are to be embraced within their scope.

A person skilled in the art will recognize that each of these sub-systems may be inter-connected and controllably connected using a variety of techniques and hardware and that the present disclosure is not limited to any specific method of connection or connection hardware.

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, a microcontroller or microcontroller based system, programmable consumer electronics, network PCs, minicomputers, mainframe computers, distributed computing environments that include any of the above systems or devices, and the like.

As used herein, instructions refer to computer-implemented steps for processing information in the system. Instructions may be implemented in software, firmware or hardware and include any type of programmed step undertaken by components of the system.

A microprocessor may be any conventional general purpose single- or multi-chip microprocessor such as a Pentium® processor, a Pentium® Pro processor, a 8051 processor, a MIPS® processor, a Power PC® processor, or an Alpha® processor. In addition, the microprocessor may be any conventional special purpose microprocessor such as a digital signal processor or a graphics processor. The microprocessor typically has conventional address lines, conventional data lines, and one or more conventional control lines.

The system may be used in connection with various operating systems such as Linux®, UNIX®, MacOS® or Microsoft Windows®.

The system control may be written in any conventional programming language such as C, C++, BASIC, Pascal, .NET (e.g., C#), or Java, and ran under a conventional operating system. C, C++, BASIC, Pascal, Java, and FORTRAN are industry standard programming languages for which many commercial compilers may be used to create executable code. The system control may also be written using interpreted languages such as Perl, Python or Ruby. Other languages may also be used such as PHP, JavaScript, and the like.

The foregoing description details certain embodiments of the systems, devices, and methods disclosed herein. It will be appreciated, however, that no matter how detailed the foregoing appears in text, the systems, devices, and methods may be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment may be included with other depicted embodiments in any combination. For example, any of the various components described herein and/or depicted in the Figures may be combined, interchanged or excluded from other embodiments.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present development. This development is susceptible to modifications in the methods and materials, as well as alterations in the fabrication methods and equipment. Such modifications will become apparent to those skilled in the art from a consideration of this disclosure or practice of the development disclosed herein. Consequently, it is not intended that this development be limited to the specific embodiments disclosed herein, but that it cover all modifications and alternatives coming within the true scope and spirit of the development as embodied in the attached claims.

As will be understood by those of skill in the art, in some embodiments, the processes set forth in the following material may be performed on a computer network. The computer network having a central server, the central server having a processor, data storage, such as databases and memories, and communications features to allow wired or wireless communication with various parts of the networks, including terminals and any other desired network access point or means.

What is claimed is:

1. A method of allowing network access comprising:
requesting, by a processor, a first set of credentials, wherein the first set of credentials allows a user access to a first application;
receiving, in a processor, the first set of credentials;
associating, by a processor, the first set of credentials with a second set of credentials, wherein the second set of credentials allows the user access to a second application, and wherein the second set of credentials are associated with a network identity;
validating the network identity of the user based on the first and second set of credentials;
allowing access to the second application according to the validated network identity according to the first set of credentials.

2. The method of claim 1 wherein the first set of credentials has a first security requirement and the second set of credentials has a second security requirement.

3. The method of claim 2 wherein validating the network identity of the user comprises evaluating the first security requirement and the second security requirement and determining whether the first security requirement of the first set of credentials is sufficient to meet the second security requirement.
